(19) United States
(12) Patent Application Publication
(10) Pub. No.: US 2010/0169960 A1
(43) Pub. Date: Jul. 1, 2010

(54) Job Search and Coaching System & Process

(75) Inventors: Steven D. Davies, Evanston, IL (US); Timothy D. Hansen, Saint Charles, IL (US)

Correspondence Address: BEEM PATENT LAW FIRM, 53 W. JACKSON BLVD., SUITE 1352, CHICAGO, IL, 60604-3787, US

(73) Assignee: Perfect Job Software Inc., Evanston, IL (US)

(21) Appl. No.: 12/347,231

(22) Filed: Dec. 31, 2008

(51) Int. Cl. H04L 9/32; G06F 3/048; G06N 5/02; G06F 7/06; G06F 17/30

(52) U.S. Cl. 726/7; 715/709; 706/47; 707/E17.044; 707/E17.045; 707/E17.014; 707/E17.005

(57) ABSTRACT

A system and process for organizing and advancing a job search of a user wherein the user provides information on one or more of contacts, documents, activities and/or status and either requests or is automatically presented with coaching to maintain and advance the search. The coaching may include creating and monitoring follow-up activities for the user. To accomplish the coaching, the system may include a rules engine for determining applicable coaching scenarios. Each scenario may be defined as a record in a database table such that each record in that table may define a unique scenario. In addition, the system may comprise a plurality of other tables defining additional records. Tables within the system may be related in a variety of ways, including one-to-one, one-to-many and/or many-to-many.

### BACKGROUND OF THE INVENTION

1. Field of the Invention

The present invention is directed to a system and process, which may include providing a coaching module, for assisting individuals in their job searches.

2. Description of the Related Art

Experts all agree that the job search process is getting more complicated every year, but that the expectations of hiring companies—for follow-up letters, preparedness, and candidate focus on them—have not changed, and may have even become stronger. Job search data gets more and more numerous as the job-seeker expands his or her network of contacts, learns about additional jobs, uncovers additional research about the companies in which he or she may be interested, etc.

Several programs deal with aspects of this information. For example, with respect to contacts, MICROSOFT OUTLOOK allows a person to store contacts and notes about the contact, but to the average user, its functionality may be limited to these features. As another example, JIBBERJOBBER.COM provides a basic to-do list, contact list and job listing but does not link information together for the user.

Neither of these systems, nor any other systems are able to compile and organize into meaningful context the volumes of data that are generated during the job search. In addition, these systems are generally strictly organizational in nature and do nothing to maintain the job-seeker's motivation or assist the job-seeker in determining what his or her next steps may be.

What is needed is a system and/or process that overcomes the drawbacks described above.

### BRIEF SUMMARY OF THE INVENTION

One aspect of the invention, a system for organizing a job search for a user, comprises: a user-modifiable database of job search related data, the data classifiable into a plurality of categories; an interactive display for presenting the job search related data; and a coaching module having a plurality of possible coaching scenarios, wherein said coaching module analyzes the data to provide specialized coaching to the user. The system may also include a rules engine, wherein the coaching module may be implemented through a series of data driven rules, and the rules engine may process the rules to determine applicable coaching scenarios. In addition, the system may include a list of current activities for the user and a plurality of follow-up activities, wherein the rules engine may determine which of the follow-up activities should be added to the current activity list.

The system may further comprise user-configurable tables of statuses, types, and categories that allow the job seeker to configure the system to match the particular requirements of their job search. Similarly, the coaching module rules and follow-ups can also be modified by the user. Users may share these personalized rules with each other, whether or not each user has personalized their system in the same way.

The system may further comprise a database having a plurality of tables, and each of the possible coaching scenarios may be stored as a record in a table in the database. In addition, the plurality of tables include a playbook table, an entity table, a category table and a detail table, as well as other, additional tables. The records in one table may have various relationships with the records in other tables. For example, the records in the detail table may have a one-to-many relationship to records in the playbook table, but one-to-one and many-to-many relationships may also exist between tables.

In another aspect of the invention, a computer program product may comprise a computer usable medium having a computer readable program code embodied therein, the computer readable program code adapted to be executed to implement a process for coaching a job-seeker, the process comprising: inputting information related to a job-search activity; analyzing the information to determine an applicable coaching scenario from a plurality of possible coaching scenarios; presenting the applicable coaching scenario to the job-seeker, which may occur automatically or be initiated by the job-seeker; and creating at least one follow-up activity. The step of analyzing may include evaluating triggering criteria for each of the plurality of possible coaching scenarios, the triggering criteria comprising at least one of entity, type or status.

In still another aspect of the invention, a method for coaching a user conducting a job search may comprise: prompting the user to enter an identifier via a machine having an input-output device; transmitting the identifier from the machine to a server; authenticating the user based on the identifier; retrieving data related to a job search for the user from a database having a plurality of tables; analyzing the data to determine possible coaching scenarios; and displaying the data to the user on a visual display. The method may further include the steps of receiving new or changed information related to said job search; storing the new or changed information in at least one of the plurality of tables of the database; reviewing the new or changed information; assessing changes to possible coaching scenarios; transmitting an updated coaching scenario to the machine; and displaying the updated coaching scenario on the visual display. The analyzing step may be performed by a rules engine through a series of data driven rules and, specifically, the server may include one or more microprocessors that performs the analyzing step.

These and other features and advantages are evident from the following description of the present invention, with reference to the accompanying drawings.

### BRIEF DESCRIPTION OF THE SEVERAL VIEWS OF THE DRAWINGS

FIG. 1 is a flow diagram representing a general overview of a coaching system and process.

FIG. 2 is an entity relationship diagram of several coaching tables.

FIG. 3 is an entity relationship diagram depicting several additional supporting tables for coaching.

FIG. 4 is a sample screenshot of a setup screen for a Coach's Playbook.

FIG. 5 is an entity relationship diagram showing many-to-many relationships between playbook and follow-up activities.

FIG. 6 is a sample screenshot of a setup screen for Follow-Up Activities.

FIG. 7 is a sample screenshot of a setup screen for a Coaching Data Dictionary.

FIG. 8 is an entity relationship diagram depicting how Coaching Data may relate to primary triggering entities.

FIG. 9 is a sample screenshot of a User Interface generated from a Post Interview Playbook.

FIG. 10 is a sample screenshot of a variation of a Coach's Playbook setup screen/User Interface.

FIG. 11 is a sample desktop screenshot.

FIG. 12 is a sample contacts screenshot.

FIG. 13 is a sample activities screenshot.

FIG. 14 is a sample documents screenshot.

### DETAILED DESCRIPTION

A computer-implemented process and system for helping job seekers manage their job search is described. The process and system may allow anyone to manage their network of contacts, monitor progress against goals, prioritize activities and ensure that they are ready for each meeting, whether it is a final interview or an unexpected incoming call.

Although job search advice books and other sources of best practices in the industry tell people that they can show them the best way to search for a job, the reality is that every job search is unique. What best practices are appropriate for one individual may change depending on any number of factors, including, for example, the industry in which the individual works, how experienced the individual is in the industry, whether the individual wants to change role or industry, the geographic location in which the individual works, the individual's personal style, etc. Adding a further layer of complexity, job searches increasingly involve large amounts of data, some of which may share relationships with other data.

The system and process may enhance the job search by providing functionality in several ways, including linking of information and coaching. Linking information may allow the user to define the relationship between pieces of information. In this way, the user may see not only what tasks he or she must accomplish but also all of the activities associated with a given contact, all of the jobs associated with a particular company, etc. Because of this context, the user may work more effectively to maintain momentum in his or her search or obtain assistance when it is needed most.

Coaching may allow the user to incorporate industry best practices and/or system-created practices into his or her search, for example by creating tasks, providing appropriate deadlines for those tasks and linking relevant information to those tasks. The coaching tool may include a process to fill in a best practice or other strategy with data relevant to coaching information and insert it into the user's to-do list. Coaching tools may be divided into modules called Playbooks that may have: a triggering entity type (e.g. Activity), a Type (e.g. “Interview”) and a status (e.g. “completed”) from which they pull context. In addition, Playbooks may have data fields that can be displayed or entered (e.g. “what worked well”) and follow-up activities that may be added to the user's to-do list. These activities may be of any type, may be linked to triggering data (either one activity per entity or all entities per activity), with a lead time and set status.

In light of all these factors, creating all of the coaching content and instruction itself for a job search and coaching system and process may be an exceedingly difficult task. To maximize a user's search and results, the system and process recognize that ultimately the users of the software may be in the best position to develop coaching content and that the system's best content role may be in coordinating and facilitating sharing of that job search coaching content.

The coaching process may provide advice integrated into the actual work that job seekers do every day. A user may request coaching that is applicable to whatever activity the user is undertaking or, alternatively, the system and process may automatically show coaching to be used, based on the user's activity and status.

In addition to static advice, the career coach may collect data from the user that is specific to the coaching being provided. That data may then be presented to the user in future coaching sessions. The system and process may also recommend follow-up activities for the user, and these activities may then be placed into a user's to-do list, for example, with an offset to the date of the activity or activities that they follow.

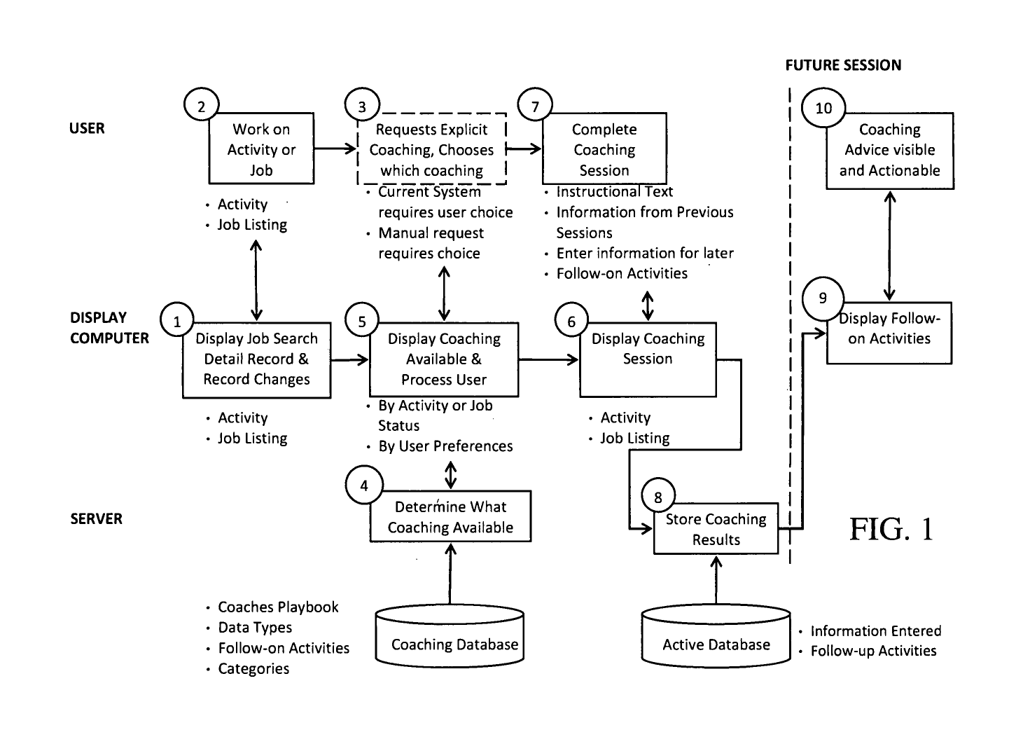

In one embodiment, the system and process may include an online repository of coaching playbooks to which users can add and from which users can select coaching. In this way, the system and process may dynamically, continuously adapt to account for newly-encountered or evolving scenarios. With reference to FIG. 1, one embodiment of the system and process is described below.

Display Job Search Detail Records and Save Changes

The system and process may display the detail records with which the user works. These records may preferably be activity detail records, but the system may anticipate providing coaching for job details and potentially for documents, contacts and organizations. For instance, a coaching wizard tied to a résumé document may provide advice to a user about best practices for drafting a résumé. To accommodate this functionality, the system may add a status field to the résumé, which may serve as a basis for coaching.

Work on Activity or Job

The coaching functionality described herein may be part of a larger system or process that has the ultimate goal of helping individuals organize their job searches to ultimately find jobs. Within those searches, activities may be specific things that a job seeker will do to pursue his or her job search. Activities may include, for example, meetings, research, calls, sending résumés, writing documents and any other activity that may be needed to pursue a job search.

As described in greater detail below, each activity may have an Activity Status, which may be an overall rating of the progress or next steps for that job. Users of the inventive system or process may be able to change the status of an Activity when they have reached a specific milestone or when they began to think about the Activity differently. Examples of status may include: “Not Started,” “In Progress,” “Blocked” or “Completed.” A user may be able to add, change or delete an Activity Status to customize the system or method to match the user's working style. Within the system and process, users may also work and track specific job openings or opportunities. Each job may have a corresponding “Job Status” that the user can use to see quickly the stage of his or her jobs. Like the Activity Status list, this list of Job Statuses can be deleted, added to or changed to match how the user works best.

Request Explicit Coaching

The system may include an option such as a link or button by which a user may request coaching at any time. In this scenario, the user may have to specify what coaching he or she wants. However, any part of the coaching module may be available as long as the prerequisites (discussed below) are met. When a user requests coaching, all playbooks that have been defined may be displayed. In another embodiment, only those playbooks having starting criteria that are met may be displayed.

Display Coaching Session

Each Coaching session may be dynamic, changing based on the activities completed or to be completed by the user, for example. In addition, each session may describe what static text needs to be displayed, what data collected, what data, if any, to display from previous coaching sessions, what entities and statuses to tie the results of the coaching record to and all follow-up records.

Complete Coaching Session

A user may read the coaching text, enter data as appropriate and select those follow-up activities he or she wishes to pursue. If multiple entities meet the requirements of the coaching session, the user may select which one or more to which information will be attached.

Store Coaching Results

The information from coaching sessions may be stored in a database. Information that is specific to coaching may be saved in a separate set of tables, by data type, for use of the coaching module. Follow-up activities may be stored as new activities, coded and tied based on the Coaching playbook and entity record to which they are associated. The user may interact with the follow-on activities as if the user entered the activities himself.

Coaching Advice Visible And Actionable

Because the advice from the Coaching module is integrated back into the normal stream of Job search activities on the to-do list, a user can make use of the advice when it is needed during the job search.

In one embodiment, the system and process may include a Peer Coaching module that comprises three systems, as described in greater detail below:

Coach Customization System: This may allow the user to modify his or her version of the coaching module data while maintaining consistency of the content and system.

Coaching Community: This system may allow individuals to make their customized coaching content visible to others who might want to use it.

Coaching Download System: This system may allow other users to take coaching content developed by other users and add it to their personal coaching module.

The system may allow Career Coaches, Outplacement Firms, and Individual Job Seekers to define a job search methodology that the system and method PerfectJob will present and enforce and may provide a way to share that methodology with other users of PerfectJob.

Managing a modem job search may require a candidate to track and maximize multiple types and streams of information. Information may be classified into a plurality of types or categories, such as: Activities, Contacts, Documents, Jobs and/or Organizations. Activities may include elements such as tasks, to-do lists and appointments. Contacts may include biographic and contextual information about people such as networking contacts and other individuals important to the job search. Documents may include who received the document, what meeting the document came from, and which organizations or job opportunities it pertains to. Jobs may include which contacts can help with the job or wield influence, background information, applicable documents, and tasks completed. Organizations can include all job opportunities being worked on, key contacts in the organization, or associated with the organization, documents, and activities.

A complete job search tool may incorporate a coaching process to be implemented through a series of data driven rules and a rules engine that processes the rules to determine applicable coaching scenarios, what information to present to the user, what information to capture from the user, and which follow-up activities should be added to the user's current list of activities.

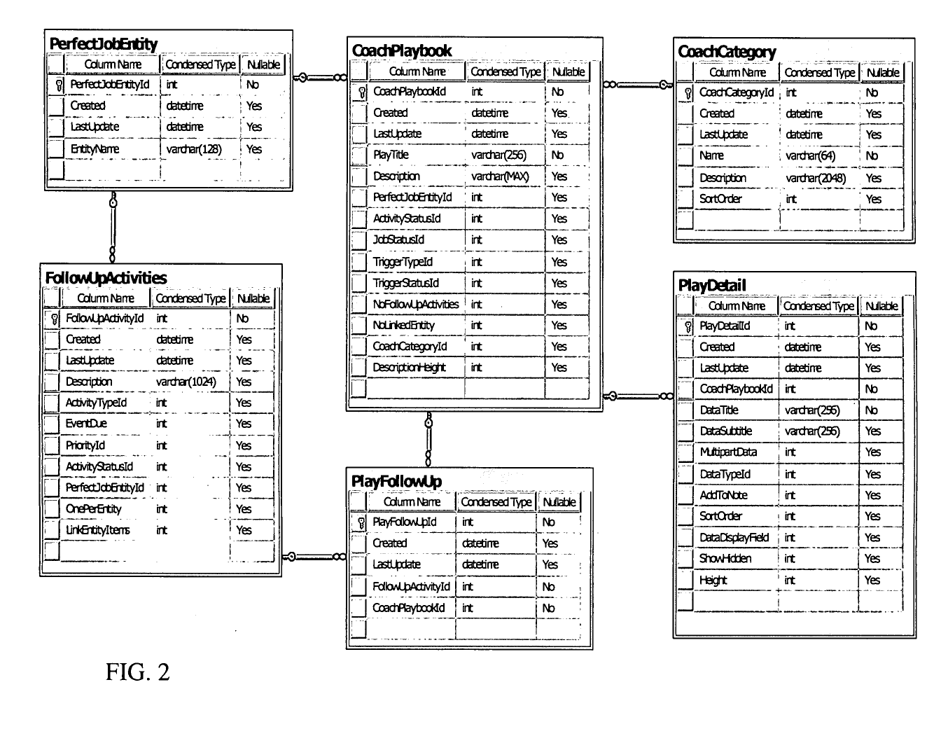

As seen in the entity-relationship diagram (ERD) of FIG. 2, each possible coaching scenario may be defined as a record in a database table referred to as the Coach's Playbook. Similarly, each record in the Playbook table may define a unique coaching scenario. Further definition of the coaching scenario may be defined in play detail records (Play Detail Table) that may have a one-to-many relationship to the Playbook table. In addition, a playbook may also have a set of predefined follow-up activities that are defined in a Follow-up Activity database table that may have a many to many relationship to the playbook table. The entries in the ERD of FIG. 2 may include entities that define a unique group of attributes that hold information about the entity. Entities have a 1 to 1 relationship with database tables. In addition, attributes, also known as columns, may be data elements defined within an entity.

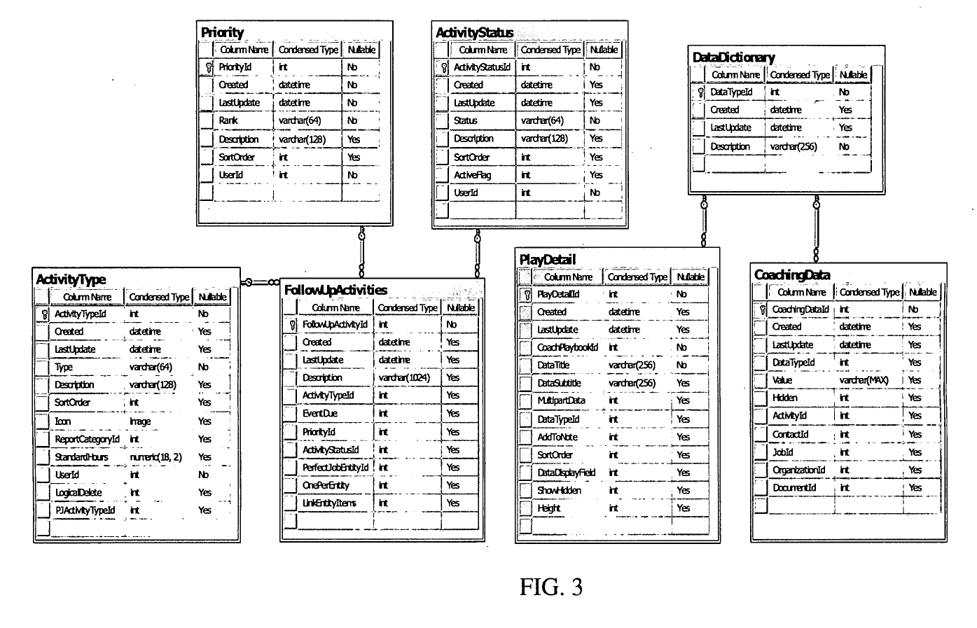

Turning to FIG. 3, additional database tables that contribute a primary role to the coaching process may include a Data Dictionary, Coaching Data, Coach Category, Perfectjob Entity, Activity Type, Activity Status, and Priority tables. The coaching process also may have relationships to many other tables within the database schema, such as activities, contacts, jobs, etc.

Determine applicable coaching (Playbook Triggering)

Users may initiate the coaching process by clicking a button to request coaching. They then may be presented with a list of all system-defined coaching scenarios, grouped by category. Each record in the Coaching Playbook table may define a coaching scenario. The Coaching Playbook table may have a one-to-many relationship to the Coaching Category table which may be used to group coaching scenarios and display them by group.

The system and process may also present users with applicable coaching scenarios based on the user's completion of a system action. For example, if a user updates the status of an Activity from “In process” to “Completed”, the system and process may be configured to present a list of applicable coaching scenarios that the user may want to perform at this time.

A coaching scenario can be performed only if the “triggering” criteria are met. Each scenario, as defined by a coaching playbook record, will contain three attributes that define the “triggering” criteria necessary for this playbook. In one embodiment, the three attributes are: Entity, Type, and Status.

The system may have and the process may employ master tables containing information on these and other attributes. For example, the Entity attribute may have elements including: Activity, Contact, Job, Document and/or Organization. The Type attribute may have elements including: Send Letter/Email, Call, Meeting, Write/Create Document, Web Research, General Research, Reminder, Review/Preparation, Incoming Call, Incoming Letter/Email, Education & Planning, Letter to Staffing Firm, Respond to Ad, Conversation—Target Organization, Conversation—Decision Maker and/or Conversation—Decision Maker Additional. In addition, the Activity Status attribute may have elements including: To Be Scheduled, Not Started, Scheduled, In Progress, Blocked, Completed and/or Deferred.

In addition to these three attributes, the master tables may include information for a Document Type attribute, including elements such as: Resume, Cover Letter, Inquiry, Thank you, Message, Background, Job Ad, Questions, Q&A, Tips and/or References. Moreover, the master tables may include information for a Job Status attribute having elements including: Lead, Resume Sent, Interviewing, Negotiation, Accepted and/or Declined.

A trigger may be defined as a combination of one, two or all three of these attributes. The Entity attribute may be the primary key that defines which of the other two attributes is applicable for this playbook record. For example and with reference to FIG. 3, if a playbook record is defined with the triggering entity as “Activity,” then the type would be one of the Activity Types from the Activity Type table, and the status would be one of the statuses from the Activity Status table. In this example, type and status are not required to be part of the triggers but may be triggers nonetheless. In the case of a triggering entity where type and/or status are not applicable, these attributes may not be available to be defined, as shown in the following table, which illustrates possible triggering entities and their applicable type and/or status records:

| Triggering Entity | Type | Status |
|---|---|---|
| Activity | Activity Type | Activity Status |
| Contact | Role | n/a |
| Job | Source | Job Status |
| Document | Document Type | n/a |
| Organization | Targeted | n/a |
| N/A | n/a | n/a |

A playbook's triggering criteria may be considered met when a record exists in the system database entity, as defined by the playbook's triggering entity. In addition, the applicable triggering attributes (type and status) also may be attributes found on the triggering entity record. For example, a Coaching Scenario comprising a Post Interview Debrief may be defined to have a triggering entity attribute of “Activity”, a triggering type attribute of “Meeting”, and a triggering status attribute of “Completed”.

Coaching User Interface based on playbook/play detail attributes

Construction of the primary user interface screen for coaching may be dynamically driven based on the rules defined in various tables, including Playbook, PlayDetail, Coching Data and Follow-up Activities tables.

Playbook attributes

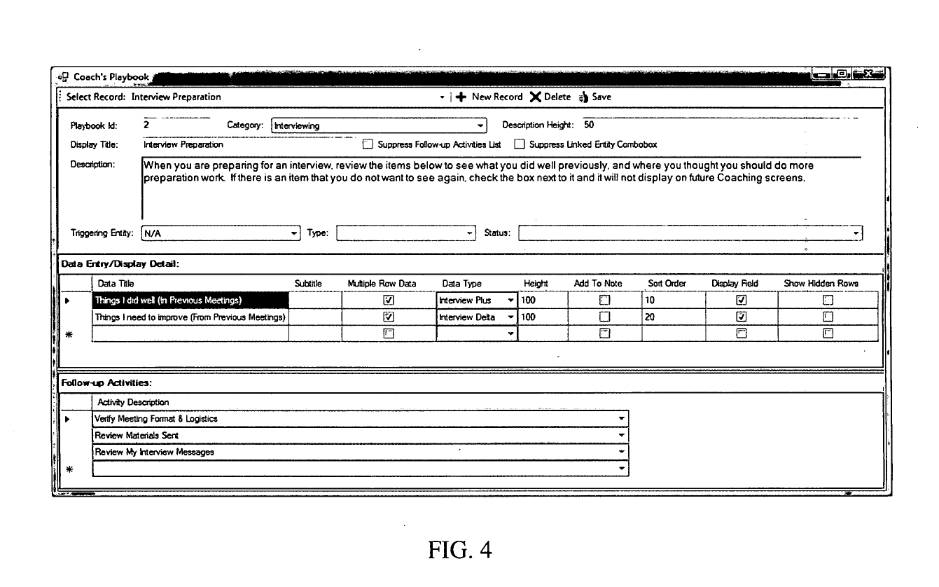

Turning to FIG. 4, one example of a coaching playbook set-up screen is shown. As seen in FIG. 4, each coaching scenario may begin with a section of introductory text that describes the purpose of the coaching and gives any relevant instructions. This text may be defined as part of the Playbook record and may contain rich text formatting (rtf) embedded within it. In addition, the size of the screen display area may be defined by a description height attribute on the playbook record.

If a particular coaching scenario does not have any applicable follow-up activities, Playbook attributes may exist to suppress the Follow-up activities list. Similarly, if the scenario does not require a triggering entity to be performed, Playbook attributes may suppress the selection of a linked entity.

Each playbook record can have one or more related play detail records. Each play detail record may be used to define data elements that should be displayed on the screen or to define data elements that are to be captured from the user during the coaching session and stored in the system database.

Play Detail attributes

Play Detail records may be defined with the following attributes:

Data Title—The field label that will be shown on the screen next to the data element.

Subtitle—An additional field label that can be displayed on the screen under the Data Title.

Multiple Row Data—A Boolean value that is used to define if this data element is comprised of one or multiple rows of data. For example, a false value will result in the screen presenting a single text box for data entry or display. A true value will result in the data being presented in a grid format, one row for each data item.

Data Type—A foreign key to the Data Dictionary table that is used to define the type of data being captured or displayed. Each play detail record may be of one and only one data dictionary type.

Height—Defines the screen height of the field in pixels.

Add to Note—A Boolean value that defines if the detail item should be added to the triggering entity note field upon completion of the coaching process.

Sort Order—A numeric value that is used to define the order that the detail records are presented in the user interface. Detail records may be sorted in an ascending sort order.

DISPLAY ONLY FIELD—A Boolean value that defines if the detail item is display or data entry. A true value means that data of the defined type will be retrieved from the Coaching Data table and displayed on the screen in this location. A value of false means that the user will be prompted to enter data in this location and the data will then be stored in the coaching data table upon completion of the coaching process.

Show Hidden Rows—A Boolean value that indicates if coaching data that has been flagged as hidden should be shown or not.

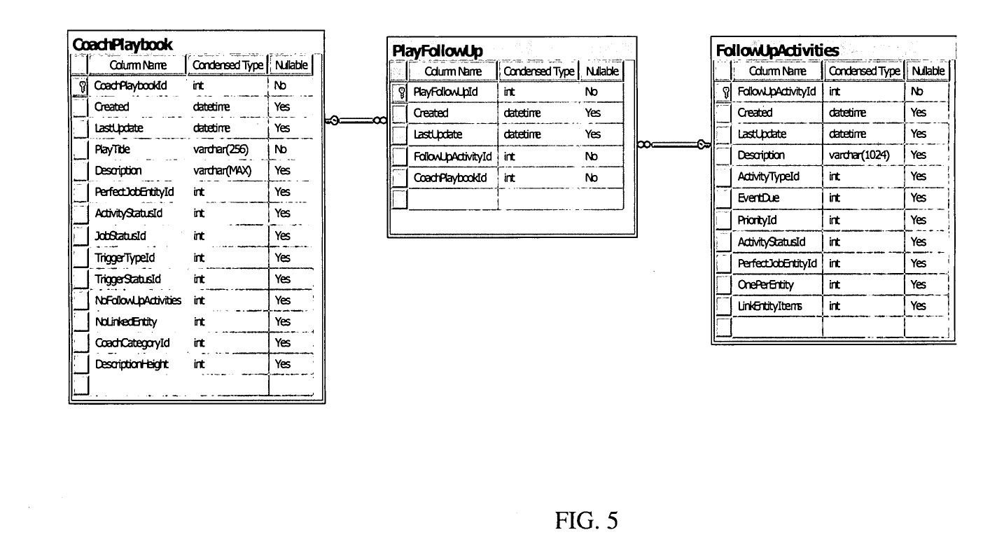

Turning to the entity relationship diagram of FIG. 5, each playbook record may also have one or more Follow-up activities associated with it. As seen in FIG. 5, the playbook table may have a many-to-many relationship with the Follow-Up Activities table.

Follow-up Activities Attributes

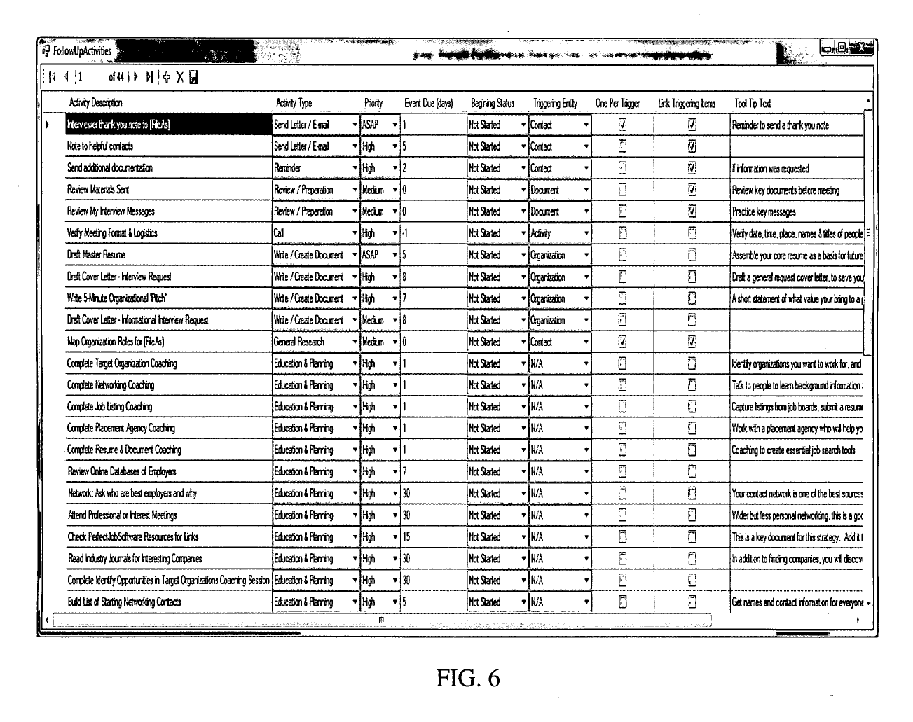

The coaching system and process may contain a plurality of follow-up activities, as can be seen in FIG. 6. As shown in this figure, and as described below, each follow-up activity may be defined with the following attributes:

Activity Description—The description of the activity that will be displayed during the coaching session and is also used to create a new activity record in the Activity table upon completion of the coaching scenario. Follow-up activity descriptions may contain other attribute names in the description that may result in a substation of the attribute name with the actual data during the coaching process. For example: “Interview thank you note to [FileAs]” may be a follow up activity. In this example “[FileAs]” is an attribute name from the Contact table and will be replaced with the associated contact's “FileAs” name when displayed as a new activity record.

Activity Type—A foreign key relationship to a Master Activity Type table that is used to set the activity type during record creation.

Priority—A foreign key relationship to a Master Priority table that is used to set the activity priority during record creation.

Event Due—A numeric value used to calculate the event due date for the follow-up activity. This value can be a positive or negative value and will be used in conjunction with the triggering entities date. For example, the follow-up activity of “Interview thank you note” may have an Event Due attribute of 1. This means that 1 day will be added to the due date of the triggering Interview Meeting activity to determine the due date for the “thank you” activity.

Beginning Status—A foreign key relationship to the Master Activity Status table that is used to define the starting activity status during record creation.

Triggering Entity—A foreign key relationship to the system Entity table that is used to define the entity that will “trigger” this follow-up activity. In one example, the follow up activity “Interviewer thank you note” may be set to be triggered by the Contact entity. This means that for each Contact that is linked to the primary triggering Activity (Interview Meeting) the system coach may create a follow-up activity to send that contact a thank you note.

One Per Trigger—A Boolean flag that is used to define if the follow-up activity should be created once for each of the triggering entities, or only once for the group. For example, for interviewer thank you notes, the system and process may be configured to alert a user to send one note to each person (contact) with whom the user met during the interview. In other cases, the system and method may be configured to take only a single action for the group of contacts.

Link Triggering Items—A Boolean flag that is used to indicate if the follow-up activity record created should be linked to the triggering entity record that triggered the follow-up activity to be created.

Tool Tip Text—Defines the text that is displayed in a “tool tip” window when the user hovers their mouse over the follow-up activity on the coaching user interface screen.

Data Dictionary Attributes

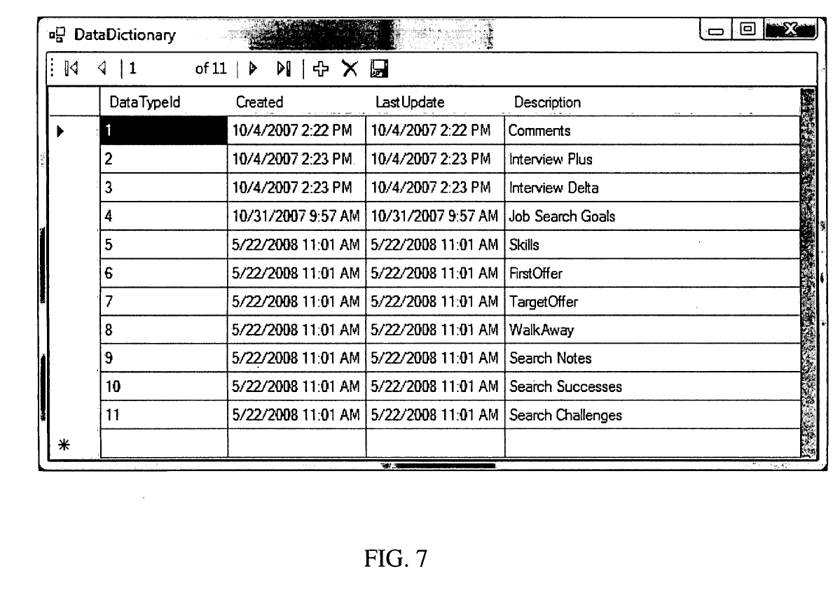

A data dictionary may be used to define data items that are stored and retrieved within the coaching process such as the items shown in FIG. 7. Each data item may be defined with the following attributes:

Data Type—The primary key attribute that uniquely identifies the data item with the coaching process.

Description—A text based description assigned to each data item that may be used to identify the data item on the user interface screens.

Coaching Data Attributes

In addition to prepackaged data and coaching tools, the system and process may contain a coaching data table that may store information entered by users during the coaching process. Each coaching data record may be defined with the following attributes:

Data Type—A foreign key relationship to the data dictionary table that identifies the type of data being stored.

Value—The actual data that the user entered during the coaching process.

Hidden—A Boolean value used to indicate if this data should be hidden or shown on the coaching screens.

Activity Id—A foreign key relationship to the activity record that was a trigger for this coaching data.

Contact Id—A foreign key relationship to the contact record that was a trigger for this coaching data.

Job Id—A foreign key relationship to the job record that was a trigger for this coaching data.

Organization Id—A foreign key relationship to the job record that was a trigger for the coaching data.

Document Id—A foreign key relationship to the document record that was a trigger for the coaching data.

User Id—A foreign key relationship to the user record that owns this coaching data.

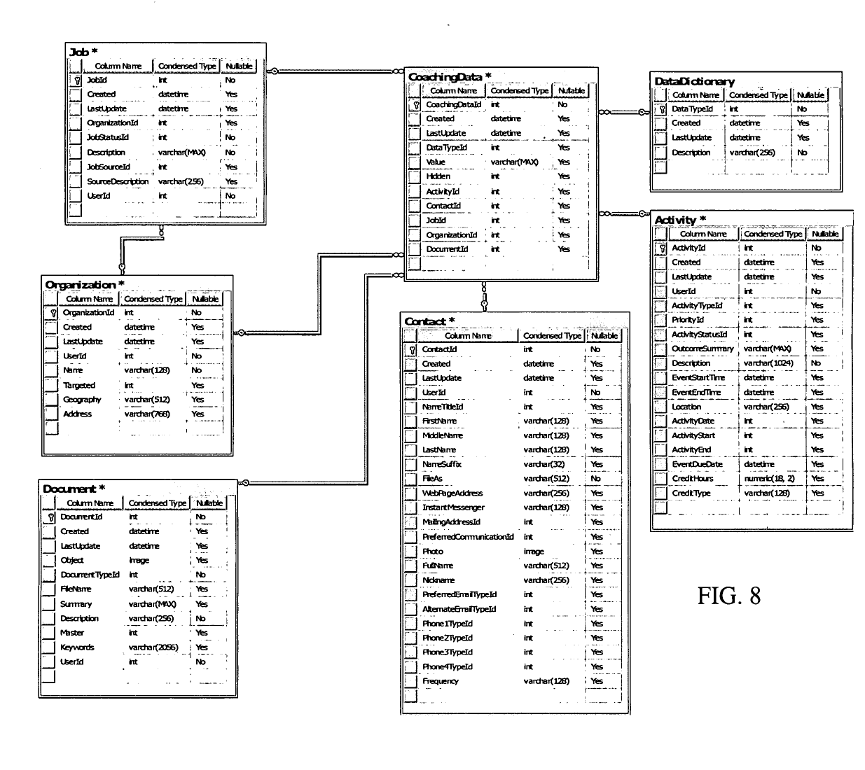

Turning to FIG. 8, one possible entity relationship diagram is shown outlining the relationships between several of the system's primary triggering entities, the coaching data table and the data dictionary table.

Populating the coaching user interface

After the above-described attributes are processed and applied, resulting in a user interface screen applicable a coaching scenario, any play detail items that are set to be display items may be retrieved from the current database. For example, returning to the “Interview Preparation” coaching scenario shown in FIG. 4, the data items “Things that need improvement” have been defined to display. In this example, “Things that need improvement” would have been captured in a previous coaching session. Following the population of the play detail data items, the list of applicable follow-up activities may then be populated with a default selection to add the follow-up activity to the PerfectJob database upon completion of the coaching scenario.

In addition, a list of triggering entities may be populated with all records from the playbook triggering entity that are applicable to this scenario. A user may then select one of the applicable triggering entity records to which the coaching scenario will be applied, which may begin the process of triggering play detail records based on the primary record selection and for whatever links exist for the primary record to other system entities. For example, if an interview activity has two linked contacts and the user selects to perform a post interview debrief coaching process, the system and process may apply the above-defined playbook to the selected activity record and the follow-up activities of “send thank you” to each of the linked contact to the interview activity.

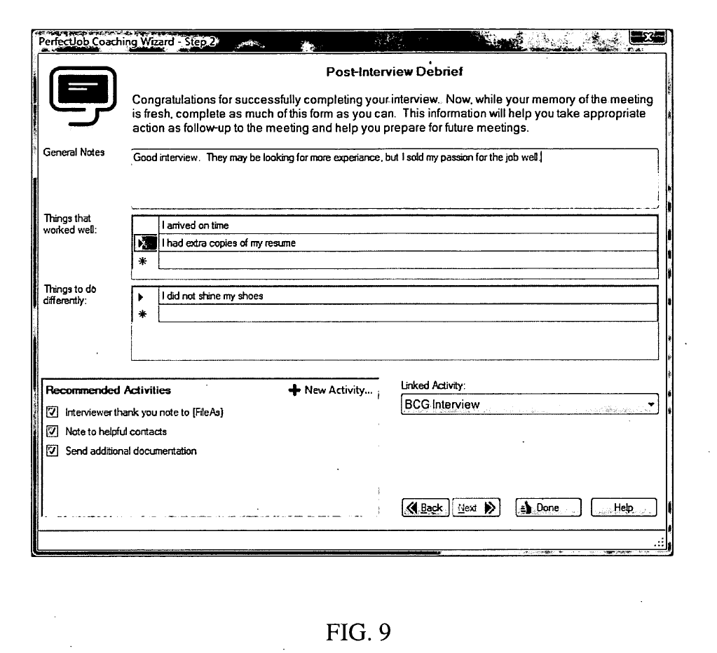

Turning to FIG. 9, for the post interview debrief scenario described above, the system and process may include a user interface generated from the post interview playbook in order to accomplish these tasks. The user interface may comprise a wizard tool that enables the user to enter notes about the activity including what went well and what did not, as well as to link other follow-up activities to the activity being described. The system and process may then record the user-input information for evaluation and record-keeping for the activity and may rely on this information when generating additional activities for the user.

Store Coaching Results

When the user completes a coaching process and clicks the “Done” button, all data entered by the user may be captured or updated into the coaching data table. If the play detail record defined a data item that was display only, then during the coaching session, the user has the option of clicking a checkbox indicating they do not want to see this information again. During this update process, the Hidden attribute on the coaching data record will be updated according.

If the play detail “Add to Note” attribute is set on any of the play detail items then a new note record may be created with the contents of each play detail record that contains this attribute and the new note record may be linked to the primary triggering entity.

Create Follow-Up Activity Records

After completing storing and updating all associated coaching results, the coaching engine within the system may then loop through all follow-up activities that have been selected to be added to the activity table. For each follow-up activity, the above-described attributes may be used to define how the follow-up activity is created and with what parameters.

For example, if a follow-up activity is configured to be triggered based on a linked entity, then the system and method first may look for the existence of the linked entity before adding the follow-up activity. Also, the attribute of “one per entity” may be applied to determine if one follow-up record is being created, or if one follow-up for each linked record is going to be created.

The new, follow-up activity record will have its status, priority, and due date set according to the attributes defined in the Follow-up activity record. If the description of the follow-up activity contains any data substation fields as per the example above, then the data substations may be performed based on the triggering linked record.

As discussed above, the Peer Coaching module may comprises a plurality of systems, including a coach customization system, a coaching community and a coaching download system.

Coach Customization System

In the Coach Customization System, the user may review all of the Coaching Playbooks in his or her system, including those that are in draft (unfinished) form, choose which one to work on, edit and make changes to the data in the Playbook, and then save the playbook.

Edit Playbook:

As seen in the figures referenced below and as described in the following sections, the system and method enable a user to make substantive edits to coaching Playbooks, for example, to customize a Playbook to the user's particular job search strategies or industries.

Select Record:

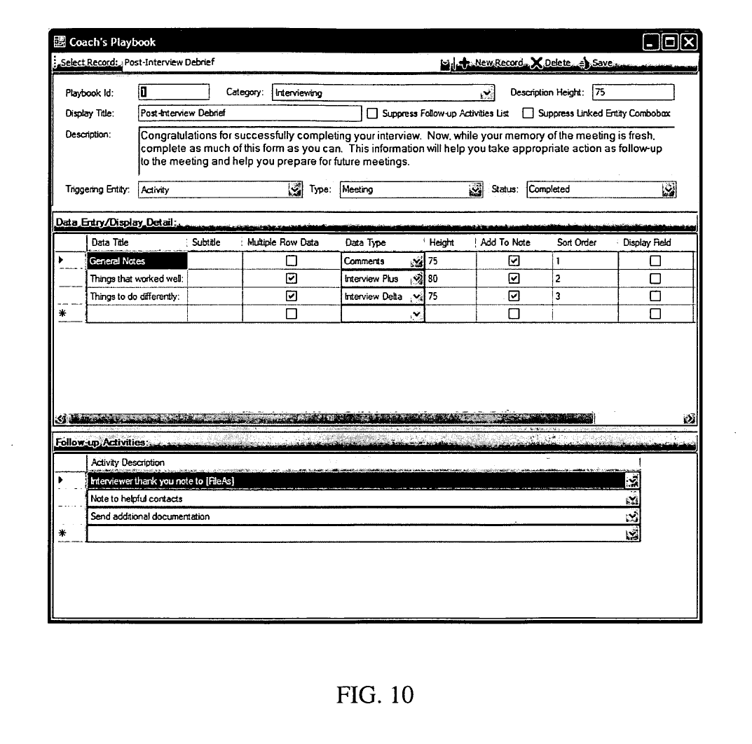

Turning to FIG. 10, another variation of a Coach's Playbook setup screen is shown. In this screen, the user selects the playbook to edit from a menu that may include a plurality of different playbooks. In addition, instead of editing an existing playbook, the user may also choose to create a new record. This user interface may also show all available playbooks, the source for each playbook (who authored it), the status of the playbook (Draft, Active, Inactive), whether it has been published (shared), and/or the triggering Entity, Type, and Status. When a plurality of different playbooks are available, the user will be able to select which record to work on from that list.

Playbook Main Information: The attributes within some of the following categories may be changed by a content author, some may be alterable by the user, and some may be changed by either entity. These attributes may include:

Playbook ID: The system may assign a unique ID to each playbook when it is created, based on a sequential record number and GUID.

Category: Each Coaching module may be assigned to a specific Category of coaching, allowing the user to browse through coaching modules if desired. The user may be able to change which category will be displayed, in turn changing the list of coaching modules that may be available

Descriptive Text: Height, Title, Description: This indicates how much of the Coaching module screen space this descriptive text should take up, how it should be titled and any explanatory text. The user can change all of this data.

Suppress Follow-up Activity: The content author can determine whether the coaching playbook will offer follow-up activities that will be added to the user's Activity list when the coaching module is complete.

Supress Linked Entity ComboBox: The author can decide whether the results of this coaching session should be attached to the triggering entity or not. If the coaching data is tied to a triggering entity, the user will be able to pick which one from a list on the coaching screen.

Triggering Entity, Type, Status: Some coaching playbooks only apply to some entities some of the time. The author can determine the conditions under which this coaching playbook should be displayed. The authoring system displays the appropriate Type and Status based on the triggering entity type.

Playbook Data Entry

The author can determine which types of coaching data this playbook should display or collect, and how much screen space each piece of data should take. The user may specify the labels for the data and how the data should be formatted. The authoring system may allow the user to add additional data types to the Coaching Playbook, as well as show information about each data type, including where it is used.

Follow-Up Activities

The author can specify which follow-up activities to display for the user and which will be added to the user's activity list once the coaching session is complete. In this screen, the Author can add already-defined Follow-up activities to this playbook or enter a new Follow-up Activity.

Using these attributes, the system and process may generate a plurality of screens for implementing the coaching module. Examples of these screens and the attributes for them may be as follows:

Setup and Strategy:

Goal: Decide search strategy

Suppress Follow-up Activities: No

Suppress Linked Entity Combobox: Yes

Triggering Entity: N/A

Type: N/A

Status: N/A

(Here, Type and Status are blank because the triggering entity is set to “N/A”. Since this coaching scenario can be run at anytime and is not triggered by a specific entity, the system may use N/A as the triggering entity. Type and Status may be defined in context to the triggering entity so that when there is no triggering entity defined, the type and status may be set to null.)

Description: The Coaching session may help the user decide what job search strategies he or she will pursue to start a search. There may be a separate Coaching session for each of the major approaches. Below, the user may select as many of the Coaching sessions as he or she wants to complete. The system and process may then add one or more Activities for each session for the user to complete.

Most people pursue several strategies at the same time. As such, the user need not worry if he changes his mind later or decides that one of the strategies is not for him. After getting started, the search will achieve a momentum of its own such that the user may feel free to delete the Activities that do not apply and re-run any Coaching session that the user thinks may be useful in the future.

Major job search starting points may be:

Target Organizations: The user may identify promising or appealing companies or organizations in the field(s) of interest and target them for the search. The user may research his or her needs, network to find information, and apply to jobs in those organizations. Of course, the user is free to pursue other opportunities as they arise, but his or her directed effort likely will be toward these organizations.

Networking: In this approach, the user may talk to everyone he or she knows, to others to whom they introduce the user, etc. Goals may be to find an organization need that is not being met, learn about opportunities that have not yet been announced and gain background information about existing opportunities.

Job Openings: Online and traditional job listings are constantly being updated. Many people, but by far, the minority of job seekers, find their next job in this way. In this strategy a user may respond to each relevant opportunity and follow up diligently.

Placement Agencies: If the user is a job seeker with experience, there is likely to be a placement agency that covers his or her industry and level of expertise. A small percentage of job seekers find their next job this way, yet it still may be a viable approach.

Résumé and Documents: While not strictly a job searching strategy, this is a set of activities that many people want to do first. It may involve creating a résumé, cover letter and personal selling messages. It is a worthwhile step that job seekers likely will want to complete early in their job searches, not matter what strategy or strategies they eventually use.

The following Data Entry/Display Details may be employed by a user or content author in describing screens of this type. As an initial matter, these details may be empty while the user configures the system or the system configures itself, which may be reflected as:

| | | MULTIPLE | | | | | DISPLAY |
|---|---|---|---|---|---|---|---|
| DATA | | ROW | DATA | | ADD TO | SORT | ONLY |
| TITLE | SUBTITLE | DATA | TYPE | HEIGHT | NOTE | ORDER | FIELD |
| N/A | N/A | N/A | N/A | N/A | N/A | N/A | N/A |

In addition, once a user has input initial search strategy information into the system, the system and process may provide Follow-up Activities for the user. In one embodiment, these activities may be organized internally as:

| | ACTIVITY | | EVENT | ACTIVITY | ENTITY | | LINK |
|---|---|---|---|---|---|---|---|
| DESCRIPTION | TYPE | PRIORITY | DUE | STATUS | TYPE | 1/ENTITY | ENTITY |
| Complete | Admin & | High | 3 | Not | N/A | | |
| Target | Strategy | | | Started | | | |
| Organization | | | | | | | |
| Coaching | | | | | | | |
| Session | | | | | | | |
| Complete | Admin & | High | 3 | Not | N/A | | |
| Networking | Strategy | | | Started | | | |
| Coaching | | | | | | | |
| Session | | | | | | | |
| Complete Job | Admin & | High | 3 | Not | N/A | | |
| Opening | Strategy | | | Started | | | |
| Coaching | | | | | | | |
| Session | | | | | | | |
| Complete | Admin & | High | 3 | Not | N/A | | |
| Placement | Strategy | | | Started | | | |
| Agency | | | | | | | |
| Coaching | | | | | | | |
| Session | | | | | | | |
| Complete | Admin & | High | 3 | Not | N/A | | |
| Resume & | Strategy | | | Started | | | |
| Documents | | | | | | | |
| Coaching | | | | | | | |
| Session | | | | | | | |

Target Organization

Suppress Follow-up Activities: No

Suppress Linked Entity Combobox: Yes

Triggering Entity: N/A

Type: N/A

Status: N/A

Description: This Coaching session may help a user set up organizations for whom he or she wants to work. These should be companies that exactly match the user's criteria for industry, geography, quality of work or quality of life needs.

The general process involved may be to:

1. Identify a group of target companies

2. Verify that the target group is sufficiently large that an appropriate job will become available in the timeframe that is desired.

3. Research each company. For example, look at their website and at online sources of information. In addition, the system and process may contain general and/or specific information about the company or its industry.

4. Begin networking into each company and contacting each company to explore what jobs are listed as available, to identify managers for whom the user may like to work and to identify internal needs that have not been announced as job openings.

5. Respond to each opportunity with a phone call, résumé, or proposal. Look at Identify Target Organization Opportunity coaching session.

Within the system or process, as the user identifies target companies, he or she may create a new organization (For example, the user may navigate to Menu option New >Organization. However, several other ways of creating new organizations may be included in the system.) for each. As the user does research, he or she may save webpages and other information as Documents that are linked to the Organization. When a webpage is stored as a document, the webpage may be converted into a PDF or other usable format and stored in the document record to preserve the document even after the webpage may change. As the user networks and discover jobs, each of those may also be linked to the Target Organization.

Once the user has set up organizations, if the Identify Target Organization Opportunity coaching session is run, it may guide the user through some of the activities needed to identify job opportunities within those organizations.

The following Data Entry/Display Details may be employed by a user or content author in describing screens of this type:

| | | MULTIPLE | | | ADD | | DISPLAY |
|---|---|---|---|---|---|---|---|
| | | ROW | DATA | | TO | SORT | ONLY |
| DATA TITLE | SUBTITLE | DATA | TYPE | HEIGHT | NOTE | ORDER | FIELD |
| Target | Name of | Yes | OrgName | 100 | Yes | 1 | No |
| Organization | Target | | | | | | |
| | Organization | | | | | | |
| Reason to | Why | Yes | OrgReason | 100 | Yes | 2 | No |
| Target | Company is | | | | | | |
| | Appealing | | | | | | |

In addition, the system or process may create and/or notify the user of several follow-up activities, which may include:

Reviewing online databases of employers;

Networking: Ask who are best employers in industry & why;

Attend professional or interest meetings and ask for recommendations;

Check PerfectJobSoftware resources for links;

Read industry journals for interesting companies; and

Complete Identify Opportunities in Target Organizations coaching session

Networking

Suppress Follow-up Activities: No

Suppress Linked Entity Combobox: Yes

Triggering Entity: N/A

Type: N/A

Status: N/A

Description: Networking is the way that most people find their next job. It works because networking can uncover opportunities before they are announced to the public, and networking also can provide an individual with information to position himself or herself perfectly.

Networking can help an individual explore new career fields, it can help uncover job leads in the ‘hidden job market’ that are never published, it can give inside information for an interview, and it can help an individual build a career within a chosen field once a new opportunity has been selected. Candidates often think that there is someone who will ‘save’ them—have the perfect job that will spare them the effort of a full job search. This rarely happens. Instead, candidates may be served better by focusing their networking on developing resources and trying to make each encounter mutually-beneficial so that there is a good chance of a follow-up conversation. Networking is not just asking each person if they have a job for you.

How it works:

1. Generate a list of contacts, including friends and family, professional contacts, and contacts through volunteer activity.

2. Call these people and ask if you can set up time to talk to them about their career. Depending on your relationship, you can ask to have them review your job search strategy.

3. Meet with them for 30 minutes or so, preferably in person, or over the phone if a personal meeting is not practical. You ask most of the questions and in return learn what they see as key issues in their industry. In addition, you can ask for advice regarding your own job search.

4. Ask for the names and phone numbers of other professionals whom you might also talk to. Often these second-order contacts are the most helpful.

5. Send a thank-you note to that contact and continue your networking efforts. You circle back to that contact when you have new news or a critical question that they are in the best position to answer.

The system and process may aid in networking by helping a user keep track of contact information, documents relating to those contacts and scheduled appointments. In addition, the coaching module may prompt a user regarding tasks to complete before and/or after meetings, such as scheduling and reminding the user to follow-up a meeting with a thank-you note.

The following Data Entry/Display Details may be employed by a user or content author in describing screens of this type:

| | | MULTIPLE | | | ADD | | DISPLAY |
|---|---|---|---|---|---|---|---|
| DATA | | ROW | DATA | | TO | SORT | ONLY |
| TITLE | SUBTITLE | DATA | TYPE | HEIGHT | NOTE | ORDER | FIELD |
| Key | Who Do | Yes | NetContact | 150 | Yes | 1 | No |
| Network | You Know | | | | | | |
| Contacts | that Can | | | | | | |
| | Help? | | | | | | |
| Network | What will | Yes | NetStory | 100 | Yes | 2 | No |
| Story | you tell | | | | | | |
| Components | networking | | | | | | |
| | contacts? | | | | | | |

In addition, the system or process may create and/or notify the user of several follow-up activities, which may include:

Building a list of starting contacts;

Developing a set of Informational Interview questions;

Developing a personal positioning statement; and

Developing a résumé.

Responding to Job Openings

Suppress Follow-up Activities: No

Suppress Linked Entity Combobox: Yes

Triggering Entity: N/A

Type: N/A

Status: N/A

Description: This job strategy includes both responding to job opportunities that are found online or through other sources, and it also includes posting a profile online on a job board where potential employers can search to find their candidates.

Responding to job openings is one of the most passive ways to pursue a job search. Success in this job approach is relatively low, but it can uncover potential jobs, so it may be a part of an overall search strategy, even if it is not the main effort a user makes. If the user already has a job but is exploring what is available, reviewing job openings and posting a profile can be the easiest way to make the user available to new opportunities.

The general approach may be to identify the type of position that are desired and analyze the specific terms being used to describe positions of that type. This analysis may result in the creation of a list of terms that potential employers are likely to use to search for profiles or filter the r6sum6s that they receive.

Because of this, a candidate should craft a r6sum6 and cover letter that highlight relevant experience and that include the target terms where appropriate. When the candidate sees an ad that looks like a good match, he or she should research the company, fine-tune the résumé and cover letter, and respond to the ad. If the candidate gets an inquiry from a potential employer, the candidate then should research and respond as the employer wants with a message refined to the employer's needs.

The following Data Entry/Display Details may be employed by a user or content author in describing screens of this type:

| | | MULTIPLE | | | ADD | | DISPLAY |
|---|---|---|---|---|---|---|---|
| DATA | | ROW | DATA | | TO | SORT | ONLY |
| TITLE | SUBTITLE | DATA | TYPE | HEIGHT | NOTE | ORDER | FIELD |
| Listing | Where | Yes | ListSource | 125 | Yes | 1 | No |
| Source | are you | | | | | | |
| | finding | | | | | | |
| | job | | | | | | |
| | listings? | | | | | | |
| Listing | What | Yes | SearchList | 100 | Yes | 2 | No |
| Search | search | | | | | | |
| Criteria | criteria | | | | | | |
| | will you | | | | | | |
| | use? | | | | | | |

In addition to providing the user with tools that may help the user accomplish these tasks as set forth in the coaching module, the system or process may create and/or notify the user of several follow-up activities, which may include:

| | | | | | | | |
|---|---|---|---|---|---|---|---|
| | ACTIVITY | | EVENT | ACTIVITY | ENTITY | | LINK |
| DESCRIPTION | TYPE | PRIORITY | DUE | STATUS | TYPE | 1/ENTITY | ENTITY |

| | | | | | |
|---|---|---|---|---|---|
| Research | Research | HIGH | 5 | Not | N/A |
| Best Job | & Prep | | | Started | |
| Boards and | | | | | |
| Set up | | | | | |
| Accounts | | | | | |
| Prepare | Write | HIGH | 5 | Not | N/A |
| Resume | Document | | | Started | |
| Prepare | Write | HIGH | 5 | Not | N/A |
| Cover Letter | Document | | | Started | |
| Prepare Job | Write | HIGH | 7 | Not | N/A |
| Board Profile | Document | | | Started | |
| Weekly Scan | Admin & | MEDIUM | 7 | Not | N/A |
| Boards for | Strategy | | | Started | |
| relevant | | | | | |
| opportunities | | | | | |

Placement Agency

Suppress Follow-up Activities: No

Suppress Linked Entity Combobox: Yes

Triggering Entity: N/A

Type: N/A

Status: N/A

Description: There are placement agencies for most industries and multiple levels of an organization. Few will work with candidates without experience, and all are focused on filling job opportunities rather than on maximizing a candidate's positioning. Rarely does a recruiter fill a position with candidates who contact them directly, unless the competition for talent is strong.

Placement agencies may be working for the companies that have positions to fill. The agencies only may get opportunities that are difficult to fill, either because of stringent job requirements, or because the candidate pool is highly sought. The best way to get an executive recruiter or other high-level agent to notice a candidate may be to become successful in his or her field. Asking how to approach search firms is the wrong question. The right question is how to make yourself attractive and accessible to them.

Before contacting a search firm, a candidate should research them to ensure that they work in the candidate's target industry. In addition, the candidate may wish to ensure that the firm works at the level being targeted and that the candidate is comfortable with the firm's reputation. Retained Search firms work at the highest levels of organizations and are paid whether they position a candidate or not. Contingency firms are paid when they place a candidate, and usually work at lower levels of the organization. Neither of these firms is paid by candidates.

When the candidate finds an agency with which he or she would like to work, the candidate may send a résumé with a note offering to help it with referrals. Once the agency has the résumé and main positioning points, the candidate does not need to check with them very often. Instead, the candidate's time may be served better by finding another agency or, better, working on other job search strategies.

The following Data Entry/Display Details may be employed by a user or content author in describing screens of this type:

| | | MULTIPLE | | | ADD | | DISPLAY |
|---|---|---|---|---|---|---|---|
| DATA | | ROW | DATA | | TO | SORT | ONLY |
| TITLE | SUBTITLE | DATA | TYPE | HEIGHT | NOTE | ORDER | FIELD |
| Agency | List | Yes | AgencyOrg | 100 | Yes | 1 | No |
| Name | Names of | | | | | | |
| | Placement | | | | | | |
| | Agencies | | | | | | |

In addition to providing the user with tools that may help the user accomplish these tasks as set forth in the coaching module, the system or process may create and/or notify the user of several follow-up activities, which may include:

| | ACTIVITY | | EVENT | ACTIVITY | ENTITY | | LINK |
|---|---|---|---|---|---|---|---|
| DESCRIPTION | TYPE | PRIORITY | DUE | STATUS | TYPE | 1/ENTITY | ENTITY |
| Research | Research | ASAP | +5 | Not | | | |
| Relevant | | | | Started | | | |
| Search | | | | | | | |
| Agencies | | | | | | | |
| Develop | Write | ASAP | +7 | Not | N/A | N/A | N/A |
| Resume | Document | | | Started | | | |
| Develop | Write | ASAP | +3 | Not | N/A | N/A | N/A |
| Personal | Document | | | Started | | | |
| Positioning | | | | | | | |

Develop Resume and Documents

Suppress Follow-up Activities: No

Suppress Linked Entity Combobox: Yes

Triggering Entity: N/A

Type: N/A

Status: N/A

Description: Many people start by developing their résumé, cover letter and other relevant documentation. This strategy may be pursued in parallel to the active job search that they conduct.

The starting point for this strategy may be to determine job search goals and defining messages. From there, the candidate may develop a résumé and cover letter, and the system and process may include utilities to help with this procedure, including, for example, providing coaching to help the user tailor the résumé and cover letter to a particular employer or industry.

The following Data Entry/Display Details may be employed by a user or content author in describing screens of this type:

| | | MULTIPLE | | | ADD | | DISPLAY |
|---|---|---|---|---|---|---|---|
| DATA | | ROW | | | TO | SORT | ONLY |
| TITLE | SUBTITLE | DATA | DATA TYPE | HEIGHT | NOTE | ORDER | FIELD |
| Key | List your | Yes | ResumeStr | 75 | Yes | 1 | No |
| Strengths | key | | | | | | |
| | strengths | | | | | | |
| Education | List | Yes | ResumeEdu | 75 | Yes | 2 | No |
| | Education | | | | | | |
| Experience | List main | Yes | ResumeExp | 75 | Yes | 3 | No |
| | experiences | | | | | | |
| Goals | List goal | Yes | ResumeGoal | 75 | Yes | 4 | No |
| | for resume | | | | | | |

In addition to providing the user with tools that may help the user accomplish these tasks as set forth in the coaching module, the system or process may create and/or notify the user of several follow-up activities, which may include:

| | ACTIVITY | | EVENT | ACTIVITY | ENTITY | | LINK |
|---|---|---|---|---|---|---|---|
| DESCRIPTION | TYPE | PRIORITY | DUE | STATUS | TYPE | 1/ENTITY | ENTITY |
| Develop | Create | ASAP | +5 | Not | N/A | N/A | N/A |
| Positioning | Document | | | Started | | | |
| Document | | | | | | | |
| Develop | Create | ASAP | +9 | Not | N/A | N/A | N/A |
| Resume | Document | | | Started | | | |
| Develop | Create | ASAP | +9 | Not | N/A | N/A | N/A |
| Cover Letter | Document | | | Started | | | |

Identify Opportunities

Goal: Connecting A User's Skills to Employer Needs

Suppress Follow-up Activities: No

Suppress Linked Entity Combobox: Yes

Triggering Entity: Organization

Type: Targeted

Status: N/A

Description: Answering the question, Why would an employer hire you? is one of the first steps in effectively positioning a user for his or her job search. The search itself is much like a marketing campaign in that the user must appeal to a specific need of the employer.

To appeal to an employer, the user must determine what skills he or she possesses and wants to use in the new job. If unsure, the coaching module may include one or more self-assessment tools to provide guidance. Once the user knows his or her skills, the user can begin to target organizations that need those skills and build his or her résumé and cover letter around them.

To make the search and networking as effective as possible, the system and process may put together “Talking Points”—which may be the things that everyone the user talks to about his or her job search should know.

The following Data Entry/Display Details may be employed by a user or content author in describing screens of this type:

| | | MULTIPLE | | | ADD | | DISPLAY |
|---|---|---|---|---|---|---|---|
| DATA | | ROW | DATA | | TO | SORT | ONLY |
| TITLE | SUBTITLE | DATA | TYPE | HEIGHT | NOTE | ORDER | FIELD |
| Portable | Skills you | Y | Skills | 100 | Yes | 1 | No |
| Skills | have gained | | | | | | |
| | that can be | | | | | | |
| | used in other | | | | | | |
| | environments | | | | | | |

In addition to providing the user with tools that may help the user accomplish these tasks as set forth in the coaching module, the system or process may create and/or notify the user of several follow-up activities, which may include:

| | ACTIVITY | | EVENT | ACTIVITY | ENTITY | | LINK |
|---|---|---|---|---|---|---|---|
| DESCRIPTION | TYPE | PRIORITY | DUE | STATUS | TYPE | 1/ENTITY | ENTITY |
| Prepare | Create | ASAP | +9 | Not | N/A | N/A | N/A |
| Resume | Document | | | Started | | | |
| Prepare | Create | ASAP | +9 | Not | N/A | N/A | N/A |
| Cover Letter | Document | | | Started | | | |
| Identify | Research | High | +15 | Not | Organization | Yes | Yes |
| Target | | | | Started | | | |
| Company | | | | | | | |
| Needs | | | | | | | |

Interviewing

Goal: Have a strong conclusion to the interview

Suppress Follow-up Activities: Yes

Suppress Linked Entity Combobox: No

Triggering Entity: Activity

Type: Meeting

Status: Scheduled

Description: The final minutes of the interview may be as important as the first ones. While first impressions set the stage for the rest of the interview, final actions in the interview will be remembered best by the interviewer. As the interview concludes, the recruiter will be assessing overall performance. As such, no matter what, it may be important for the candidate to remain enthusiastic and courteous.

Recap the next steps in the interview process and what the timeframes are. If unsure, it is perfectly acceptable to ask for clarification, both as to process (“What are the next steps?”) and as to timeframes (“How long do you think that process will take?” or “When do you expect to reach a decision?”). If the user has additional information to provide or is unsure whether additional information is needed, the user may confirm what is being provided or ask if there is anything else they need.

The user should end the interview strongly. Shake the interviewer's hand. Thank them for their time and the opportunity to interview. If the user does not have the interviewer's full contact information, the user may find it beneficial to ask them for a business card.

When you are done, leave. Do not reopen conversation as you leave, and do not offer other things that you forgot.

The following Data Entry/Display Details may be employed by a user or content author in describing screens of this type:

| | | MULTIPLE | | | ADD | | |
|---|---|---|---|---|---|---|---|
| DATA | | ROW | DATA | | TO | SORT | DISPLAY |
| TITLE | SUBTITLE | DATA | TYPE | HEIGHT | NOTE | ORDER | FIELD |
| Key | Review | Yes | ResumeStr | 100 | No | 1 | Yes |
| Strengths | Personal | | | | | | |
| | Strengths | | | | | | |
| | for | | | | | | |
| | Interview | | | | | | |

In addition to providing the user with tools that may help the user accomplish these tasks as set forth in the coaching module, the system or process may create and/or notify the user of several follow-up activities, which may include:

| | ACTIVITY | | EVENT | ACTIVITY | ENTITY | | LINK |
|---|---|---|---|---|---|---|---|
| DESCRIPTION | TYPE | PRIORITY | DUE | STATUS | TYPE | 1/ENTITY | ENTITY |
| Send Thank | Send | ASAP | +1 | Not | Contact | Yes | Yes |
| You to All | Letter | | | Started | | | |
| Interviewers | | | | | | | |
| Send Thank | Send | High | +1 | Not | Contact | No | Yes |
| You to | Letter | | | Started | | | |
| Supporters | | | | | | | |

Negotiation/Preparing for Negotiation

Suppress Follow-up Activities: No

Suppress Linked Entity Combobox: Yes

Triggering Entity: Job

Type: N/A

Status: In Negotiation

Description: Preparation for the negotiation is one of the most important things a user can do. By gathering some information and setting a few targets, the user may emerge from the conversation feeling that he or she has gotten what he or she needs, and the best deal that is possible under the circumstances.

Most negotiation consists of sharing of information and attempts to bring the other party to move toward a desired outcome. In a good job negotiation, each party should emerge with a healthy respect for the other, paving the way for a strong job start for the candidate. To accomplish this, the system and process may remind the candidate to:

Negotiate over the full range of job components, from salary to vacation, to flexibility, to time between performance reviews, to responsibilities and duties, to other benefits;

Do your research before the negotiation. Find out as much about the job and compensation of others in the company, and find out industry norms. Previous networking can help here;

Decide a ‘walking-away’ point. What are the items and compensation levels that would cause the candidate to say, “Having no job is better than accepting a job under these conditions;”

Decide a starting point: What is the most the candidate could ask from the company, across all important components of the job description and compensation, without having the company stop negotiation right there;

Decide a target point: What is the offer the candidate wants to get from the company. This should be below the “Starting Point” but above your “Walking Away Point.” This target should be the one that you are negotiating to;

Try not to be the first to offer a specific number or package. Usually the party that first makes an offer gives the most away. If required to give a number, e.g. for salary, try to offer a range and keep options open to negotiate other components of compensation; and

Be ready with explanations why the candidate chose the numbers that he or she offered or wants. The other party may be more likely to accept them, and to see the candidate as a good negotiating party if the candidate explains why the candidate wants what he or she wants.

The following Data Entry/Display Details may be employed by a user or content author in describing screens of this type:

| | | MULTIPLE | | | ADD | | DISPLAY |
|---|---|---|---|---|---|---|---|
| DATA | | ROW | DATA | | TO | SORT | ONLY |
| TITLE | SUBTITLE | DATA | TYPE | HEIGHT | NOTE | ORDER | FIELD |
| FirstOffer | Set First | No | Offer1 | 30 | Yes | 2 | No |
| | Offer | | | | | | |
| | Point | | | | | | |
| TargetOffer | Set | No | Offer2 | 30 | Yes | 1 | No |
| | Target | | | | | | |
| | Deal | | | | | | |
| | (What | | | | | | |
| | You | | | | | | |
| | Want) | | | | | | |
| WalkAway | Set Point | No | Offer3 | 30 | Yes | 3 | No |
| | at Which | | | | | | |
| | you Walk | | | | | | |
| | Away | | | | | | |

After the Search

Suppress Follow-up Activities: No

Suppress Linked Entity Combobox: No

Triggering Entity: Job

Type: N/A

Status: Accepted

Description: How the candidate finishes an active search is almost as important as how he or she conducts it. While congratulations are in order for finding the next position, it may be important to remember that in this environment, the typical person has 10 jobs between the ages of 18 and 36. Therefore, the final step of this active search may be the first step of the next job search.

As usual, the user then should review the follow-on activities presented by the system and process and decide which ones he or she should do. The important things to remember here may be to:

Thank all of the people who helped the user in the search, whether or not their help led directly to the offer that was accepted. Doing this may make those people more willing to help in the future. In addition, the candidate should make sure any note includes updated contact information;

Gracefully stop all other open searches by notifying each company that is considering the candidate and each staffing firm with whom the candidate may be working;

Update online information: If the candidate has a résumé published on the internet, he or she should decide whether to take it down or just to update the information. In addition, he or she should update social networking and job search site profiles;

Review the search: Look at statistics and run the Search Debrief coaching session. Record lessons learned for next time; and

Commit to Networking: The next search may be easier if the network of search contacts stays healthy. Commit to periodically communicate with key members of the network.

The following Data Entry/Display Details may be employed by a user or content author in describing screens of this type:

| | | MULTIPLE | | | ADD | | |
|---|---|---|---|---|---|---|---|
| DATA | | ROW | | | TO | SORT | DISPLAY |
| TITLE | SUBTITLE | DATA | DATA TYPE | HEIGHT | NOTE | ORDER | ONLY FIELD |
| N/A | N/A | N/A | N/A | N/A | N/A | N/A | N/A |

In addition to providing the user with tools that may help the user accomplish these tasks as set forth in the coaching module, the system or process may create and/or notify the user of several follow-up activities, which may include:

| | ACTIVITY | | EVENT | ACTIVITY | ENTITY | | LINK |
|---|---|---|---|---|---|---|---|
| DESCRIPTION | TYPE | PRIORITY | DUE | STATUS | TYPE | 1/ENTITY | ENTITY |
| Send Thank- | Send | High | +15 | Not | Activity | No | Yes |
| you to all | Letter | | | Started | | | |
| Contacts | | | | | | | |
| Send | Send | High | +5 | Not | Activity | Yes | Yes |
| Withdrawal | Letter | | | Started | | | |
| to Active | | | | | | | |
| Jobs | | | | | | | |
| Update | Reminder | Medium | +15 | Not | Activity | No | No |
| Online | | | | Started | | | |
| Information | | | | | | | |
| with New Job | | | | | | | |
| Review | Reminder | High | +5 | Not | Activity | No | No |
| Search | | | | Started | | | |

Post Search Debrief

Suppress Follow-up Activities: Yes

Suppress Linked Entity Combobox: Yes

Triggering Entity: Job

Type: N/A

Status: Accepted

Description: Once the user has found a new position, he or she should take a few minutes now to record some basic information about this job search, what worked well and what things he or she would do differently. When it is time to search again for a job, he or she may appreciate how much this can jump-start the next search. In this way, the system and process may possess further dynamic properties, adjusting from search to search in addition to making adjustments within a single search.

The following Data Entry/Display Details may be employed by a user or content author in describing screens of this type:

| | | MULTIPLE | | | ADD | | DISPLAY |
|---|---|---|---|---|---|---|---|
| DATA | | ROW | | | TO | SORT | ONLY |
| TITLE | SUBTITLE | DATA | DATA TYPE | HEIGHT | NOTE | ORDER | FIELD |
| Plus | Things that | Yes | InterviewPlus | 100 | Yes | 1 | Yes |
| | went well | | | | | | |
| Delta | Items to | Yes | InterviewDelta | 100 | Yes | 2 | Yes |
| | Do Better | | | | | | |
| Search | Write an | No | | | Yes | 1 | No |
| Notes | overview | | | | | | |
| | of your | | | | | | |
| | search: | | | | | | |
| | Goals, | | | | | | |
| | constraints, | | | | | | |
| | and | | | | | | |
| | general | | | | | | |
| | approach. | | | | | | |
| Search | What | Yes | | | Yes | 2 | No |
| Successes | worked | | | | | | |
| | well during | | | | | | |
| | this | | | | | | |
| | search? | | | | | | |
| Search | What | Yes | | | Yes | 3 | NO |
| Challenges | would you | | | | | | |
| | do | | | | | | |
| | differently | | | | | | |
| | on your | | | | | | |
| | next | | | | | | |
| | search? | | | | | | |

In addition to providing the user with tools that may help the user accomplish these tasks as set forth in the coaching module, the system or process may create and/or notify the user of several follow-up activities, which may include:

| | ACTIVITY | | EVENT | ACTIVITY | ENTITY | | LINK |
|---|---|---|---|---|---|---|---|
| DESCRIPTION | TYPE | PRIORITY | DUE | STATUS | TYPE | 1/ENTITY | ENTITY |
| N/A | N/A | N/A | N/A | N/A | N/A | N/A | N/A |

Publication

When the author is finished altering the Playbook and associated data, he may save the Playbook so that it does not overwrite the original Playbook, or he can save the playbook over the original.

When the user attempts to save a playbook, the system may check the playbook to ensure that the Playbook number is unique, that the combination of data display and entry fields does not exceed the screen display size and that a valid set of parameters are entered for the Playbook.

In addition, an Edit Playbook System may warn the user if the user attempts to save a playbook with the same Trigger Entity, Type, and Status of an existing Playbook, if this playbook is displaying data that is not entered in any other Playbook, or if this Playbook allows the user to enter data that is not used in any other Playbook.

The user has the choice to save the playbook as a Draft or Active record. Active records are immediately made available for that user's next Coaching session within PerfectJob. Draft records are stored in the system but are only accessible by the Playbook Editing system.

In addition, the author may decide whether to make the Playbook available to other users of the system and method through implementation of a Coaching Community. If the author does make the Playbook available to others, the Playbook GUID is validated as unique against a Coaching Community master list of Playbooks. If the GUID is found in the community master list, then the author is asked to provide a description of the changes to the existing playbook. If the GUID is not found, it is a new playbook and the author is asked to log into the Community if he is not already logged in, to provide a name for the Coaching Playbook, and optionally provide a description of the contents and purpose of the Playbook.

If this author already has playbooks published in the Community, he will have the option of adding this playbook to an already-existing group of playbooks or creating a new group of playbooks. The author may also be prompted to enter or edit a set of keywords associated with this Playbook or overwrite an existing Playbook if appropriate.

Within a Group of Playbooks, the author/user may be warned if there is duplication of Entity/Type/Status or incomplete data entry fields (either fields that are displayed without being input, or input without being displayed).

When entry is complete, the data will be added to the Community Database, along with the user unique information, creation date, update date, etc. At this point the data may be accessible to the moderators of the Coaching Community and, in order to aid in locating the playbook within the community, the Playbook author may categorize the Job Search Methodology based on set criteria, such as industry, career stage, and geography.

Coaching Community

The Coaching Community of the system and method may be a place where individuals can see what customized Coaching Playbooks are available for the system and method and exchange information with other users of the system and method. Users may see lists of available Coaching Playbooks, sorted and filtered based on category, keywords, industry, and career stage.

A user may mark individual Coaching Playbooks, or groups of Coaching Playbooks, so that he can easily return to see what has changed. In addition, he can view comments of other users about specific Playbooks, groups of playbooks, or other Job-search topics. He may also add his own comments.

The Coaching Community may have moderators that review each coaching playbook before it is made available to the community as a whole. In addition to reviews for appropriate content, the Moderators may review the keywords, categories, and other identifying information about the Coaching Playbook and adjust them as needed. The moderators may publish or reject each Playbook. The system presents the Moderators with a list of all submitted content, allowing them to review the information, and either reject it or publish it to the Coaching Community.

If the Coaching Playbook is rejected, the Moderator may add a set of comments about why the Playbook was rejected. The Author can then review the status of each Submitted playbook and read comments as available.

Coaching Download System

The Coaching Download System may comprise functions to load select Coaching Playbooks and Playbook groups from the Coaching Community to the user's system and to reconcile the new and existing Playbooks.

Loading selected Coaching Playbooks into a user's database may be as simple as copying the data records from the Community database to the user's system database. The records may be marked as pending or temporary until the user reviews and approves them.

In one embodiment, the user must review and approve all of the pending records before they are activated within the system. Review may be one-by-one, or alternatively, an entire group of records may be compiled, reviewed and approved together.

The system may check records for duplicate record numbers and ask the user to resolve any numbering incompatibilities before importing the records. Whenever the system finds that a new record duplicates the Triggering Entity/Type/Status of an existing record, it may prompt the user whether to keep the existing record, add the new record and delete the existing record, or keep both records in the database. The user may want multiple coaching sessions for the same triggering conditions, if, for instance, they are pursuing multiple types of job, and one set of Coaching Playbooks is more appropriate for one career than the other.

The coaching system and process may be part of a larger system and/or process for organizing a user's job search to keep the user focused, to remind the user of the practices that have had success for him or her in the past and to highlight those areas in which the user may benefit from additional guidance. Although this larger system and process will be described in greater detail below, additional information about the system and process may be found in the document “PerfectJob Software, Getting Started,” the contents of which are incorporated herein by reference.

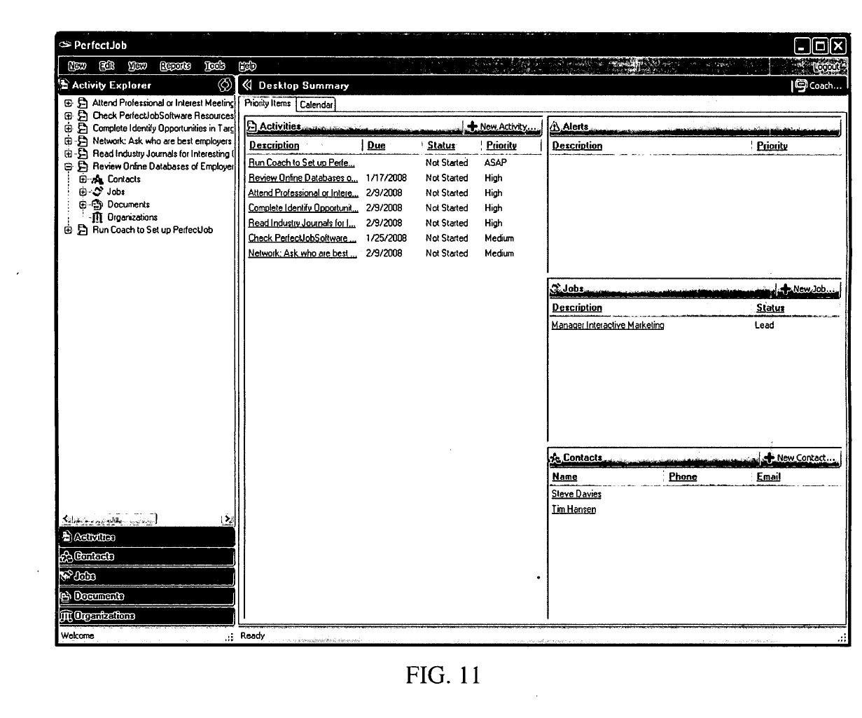

As seen in an exemplary screenshot in FIG. 11, that larger system may include an initial screen that provides multiple functionalities to the user. For example, the system may:

Provide a single point to manage the important items of the job search: Activities, Contacts, and Jobs;

Allow the user to see interrelations between data from a navigation panel such as the one shown on the left side of FIG. 11; and

Enable the user to go immediately to any information of interest.

In the embodiment shown in FIG. 11, the simple window structure may be familiar to most computer users, which may make the system easier to use.

That larger system may aid the user in the following areas:

Managing A Network of Contacts

The system and process may track relevant information about the people the user knows, and who might be able to help in the job search. In addition to basic contact information about them, the software also may track important dates and may track references they have made for you and what results have come from those references. Moreover, the software may suggest sending a note or provide some other method of reminding a user about follow-up to the user's referring contacts so that they stay current on the job search and want to help again.

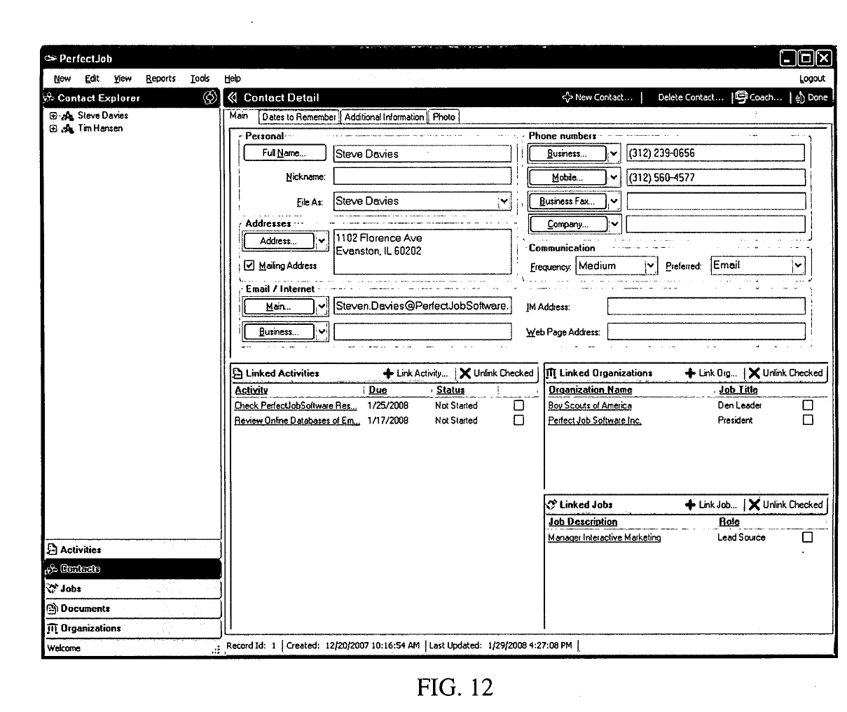

Turning to FIG. 12, a sample screenshot of a contact screen is shown. As seen in FIG. 12, the system may show all critical information for networking contacts in one place, including photo, and all contact information. The system may also enable a user to see a full picture of each Contact through Linked Activities, multiple Organizations, Jobs, and on the Additional Information tab, Documents and Contact relationships. In addition, the user may quickly record notes on each Contact. Further, the system may allow a user to keep networks active through an innovative “Undercommunicated” report that shows contacts with whom the user has had less contact than he or she would like. Moreover, the contact screen may list Dates to Remember for each contact, for example, to provide opportunities to reconnect. Through its linking capabilities, the system may also allow the user to store or navigate to linked Documents that contain research, articles of interest, resumes and cover letters sent. In short, the system may present anything of interest to the user or relating to the Contact.

Managing Activities

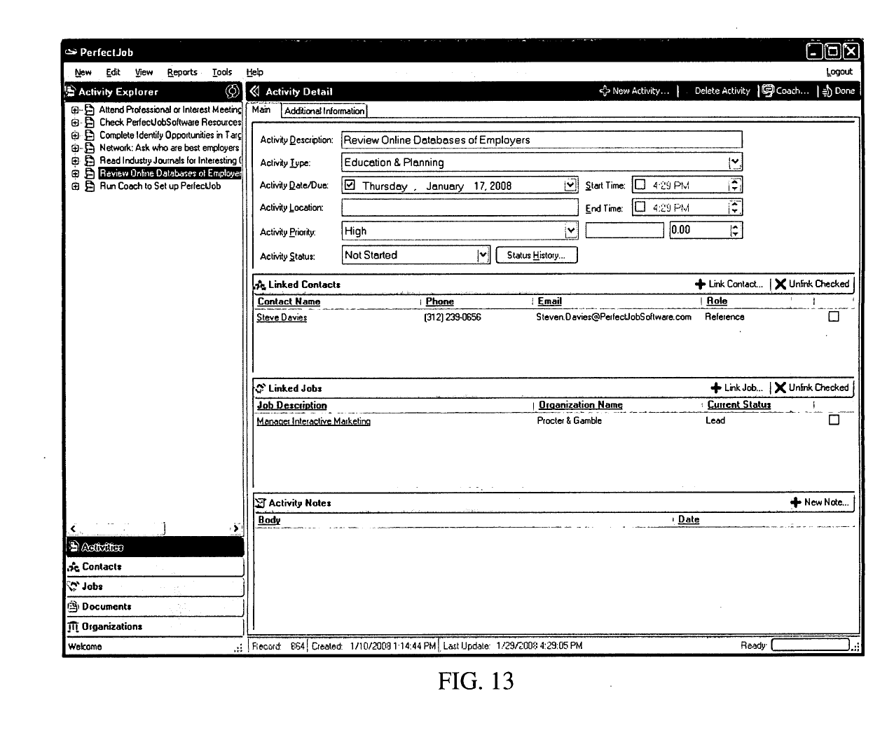

Similar to the options available for managing contacts, the system and process may also allow the user to manage multiple activities related to the job search, as seen in the exemplary screenshot of FIG. 13. In this way, the system may track personal to-dos, meetings, along with any linked Contacts, Jobs, Notes, Organizations, and Documents. In addition, a complete Activity status and history may remind the user when he or she last moved an activity forward, may provide the user with the impetus to continually remain active in the job search and not let any part of it idle. This forward progress may be increased through reporting accuracy generated by the Activity Types and Activity Status fields.

Managing Documents

Users often have multiple versions of their résumés for different opportunities and from different times of their job searches. It may be beneficial or even necessary to track all of these and know to whom they have been sent. In addition, a user may have multiple versions of a cover letter, and the user will want to keep his or her message consistent when talking to one person. Moreover, the user may have writing samples, publication lists, recommendations and other supporting documents, all of which he or she wants to keep track of. The system or process helps manage all of these job-related documents by allowing you to link all of them to one or more contacts, activities, jobs, etc. and to distinguish between multiple versions of the same document, for example, by enabling a user to provide notes about each document for easy review and recognition.

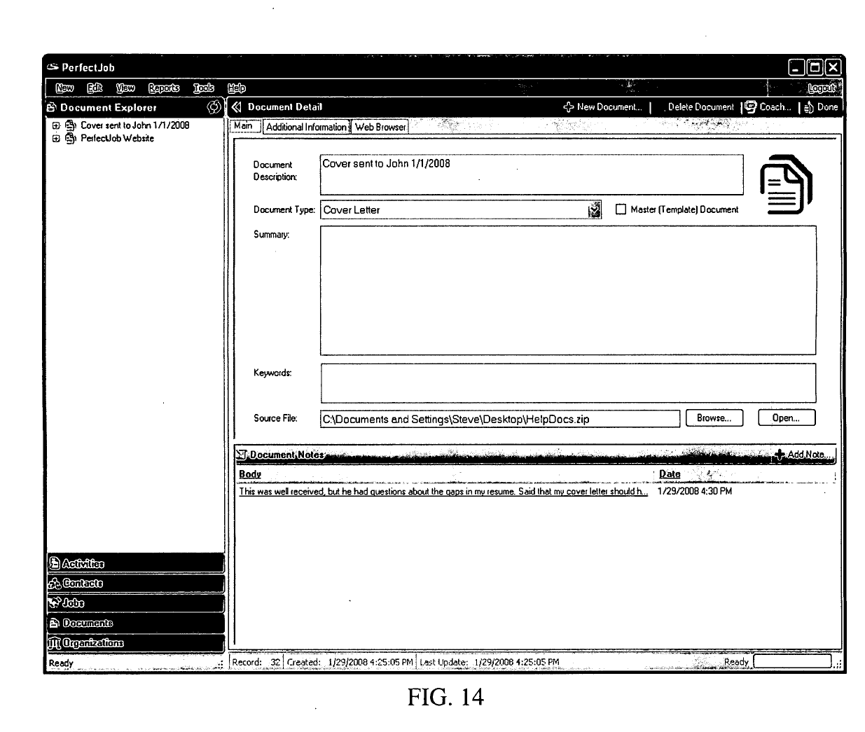

Turning to FIG. 14, the sample screenshot shows how the system and process may allow the user to accomplish these goals. As can be seen in FIG. 14, the system may keep every type of relevant document, from resume and cover letter, to captured job listing, to website research, to Linked-In connections. This may allow the user to find what he or she needs quickly through links to relevant information that are associated with each document. In addition, this section may allow the user to capture helpful websites quickly through an integrated web browser and retain the links to that information and/or turn that information into an additional document.

The benefits presented by such a system are numerous. For example, and without limitation, the system may orient and quickly prepare a user for incoming phone calls by accessing documents relevant to the caller. It may also enable the user to prepare for interviews and applications by collecting all background and reference materials in one place.

Managing Opportunities

A modern job search may require pursuit of multiple opportunities at one time and continual attention to ensure that nothing gets lost along the way. The system and process may help a user manage this workload by showing current to-dos and the number of opportunities at each stage of the user's search. This information may not only help the user handle the most important items each day so that nothing is lost, it also may allow the user to focus extra time on the areas that need more work.

Managing research

The modern job seeker must research the people with whom he or she meets and gather as much background information about specific companies, industries, and job opportunities in which he or she is interested. That information can come from many sources, but increasingly it comes from website captures, web addresses, or other electronic sources.

The system and process may track all of the information that a user collects and allows the user to tie it to specific opportunities, people, and companies, or just keep it for general information. When a user recalls information about one of the linked subjects, the system and process may provide links to the information that has been saved so that he or she quickly can review all relevant information.

Quick Access

Never be caught flat-footed again when answering the telephone. The system allows a user to pull up contact information, meeting notes, and opportunity information quickly to respond instantly to an unexpected call from someone with whom the user previously may have met. By having the information about last meeting, next steps, documents sent and background information, the user can handle phone calls eloquently while still managing multiple job searches.

Embedded Expertise

The system and process may incorporate the best advice of the best job search and recruiting experts in the industry. That advice is embedded in the functioning of the program, guiding the user to better job search experience. For example, instead of advising the user that meeting follow-up is important, the system may ask the user how long he or she wants to wait before sending a “Thank-you” note or to call for feedback. However, the system and process also understand that some job searches have specific needs and that, for some industries, certain practices are expected. For this reason, the system and process enable a user to configure the software prompts and next steps. If you never want to send a thank-you note, you can configure the software to never remind you. If you want to send a résumé and list of publications after each meeting, you can add that to the list of prompts.

In addition to, or as part of, the coaching elements, the system and process may also include the following functions and features:

Daily Calendar

Show scheduled Appointments, Interviews, and calls. Show needed phone calls. Show new referrals. Show document mailings and e-mails needed.

Meeting Preparation

Quick access to current information about Opportunity, Contact, Company, etc. Capture new research. Prompt for meeting goals and expected outcomes. Checklist for meeting (directions & map, resume, etc).

Meeting Follow-Up

Capture meeting notes. Enter next steps and target dates. Provide modification of meeting preparation checklists and tasks. Allow mail merge to send notes as appropriate

Campaign Overview

Table and graphical view of all activities, grouped by stage of opportunity. Statistical view of activities and progress.

Network Management

Record each contact's information. Record and review all meetings, referrals, letters, etc. Manage background information on contact. Automatically include follow-up tasks based on key Contact dates.

Manage Résumés and Other Documents

Add multiple versions of document. Send out any version of résumé under standard name, e.g. “John Doe Resume.” Track which resumes sent to which contacts, as well as success rates of each resume.

Manage Mailing Lists

Allow import of any mailing list in standard format. Mail merge mailing list and cover letters to be printed or e-mailed. Track response rate for mailing lists

Opportunity Tracking

Review of all activities tied to opportunity. Automatic tasks added when no activity within a certain time period.

Job Search Wizard

Help you set up the system to match your job search, one step at a time. Suggest potential tasks to prepare for each meeting. Suggest potential and recommended follow-up to each meeting. Draw your attention to useful features of Software that you might not know about.

Integration

Integrate with Microsoft Outlook and other popular e-mail systems to automate mail handling. Integrate with Explorer and other web browsers to automate capture of web-based research.

The system and process may be installed and run locally on machine such as a personal computer such as a desktop or laptop running MICROSOFT WINDOWS XP or VISTA. Alternatively, the system and process may be installed remotely, for example, on a server, and be accessible remotely via Internet, LAN or WAN connection. In that case, the system may still be accessible by the user's computer or by another form of machine, such as a wireless handheld unit, cell phone, PDA, etc. The user's machine may include an input/output device such as a keyboard, keypad, touch screen keyboard emulator or other device. In addition, the user's machine may include a display for providing visual signals to the user such as a computer monitor, lcd screen or other display. The I/O device and the display may be separate, as in the case of a computer monitor and keyboard, or they may overlap, as in the case of a touch-screen monitor.

In either a local or a remote installation, the system may include one or more databases having a plurality of tables that may have relationships as described herein, and the system may include one or more processors or microprocessors for analyzing data and determining possible coaching scenarios. The system may include, or the process may run on, any version of MICROSOFT SQL Server (SQL Express 2005, SQL Workgroup 2005, or SQL Enterprise 2005) for its database engine. A desktop application may run on a WINDOWS based desktop or laptop with WINDOWS XP or later operating systems. A Web Edition may run on a WINDOWS based server using MICROSOFT SERVER 2003 or later and Internet Information Services. Both the local and web editions may utilize identical database schemas. In addition, minimum database storage size may be about 10 MB for a single user environment.

The system and process may not require any additional system resources other than those required for the operating system and database engine to run, but the use of other resources is not prohibited. The system and process may use SSL for secure communications between client and server. Moreover, the system and process may use a Software Publishers Certificate issued by a Certified Authority to sign all published executable and installation files.

In this way, the system may prompt the user or require the user to enter an identifier to begin a session. The identifier may be checked internally in the case of a local installation or transmitted to the server in the remote situation case to verify the user's identity or rights to data maintained within the system. Once verified, the system may retrieve the user's data, including information pertaining to the user's job search such as contacts, documents, etc., and present that data to the user. The system, via the rules engine and microprocessor, may also analyze at least a part of the data to determine possible coaching scenarios, evaluate previous coaching scenarios and/or determine what, if any, other data may be relevant to those scenarios. Upon a request for coaching, the system may query the database tables to retrieve relevant information, arrange that information according to the parameters defined by the system and/or the user, transmit the information to the user's machine in the case of a remote install and present that information to the user, for example by displaying it in one or more forms on one or more screens of the user's machine's display.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A system for organizing a job search for a user, comprising:
a user-modifiable database of job search related data, said data classifiable into a plurality of categories;
an interactive display for presenting said job search related data; and
a coaching module, wherein said coaching module analyzes said data to provide specialized coaching to said user.

2. A system according to claim 1, further comprising: a rules engine;
wherein said coaching module is implemented through a series of data driven rules and further wherein said rules engine processes the rules to determine applicable coaching scenarios.

3. A system according to claim 2, further comprising:
a list of current activities for said user; and
a plurality of follow-up activities,
wherein said rules engine determines which of said plurality of follow-up activities to add to said list of current activities.

4. A system according to claim 1, wherein said coaching module comprises a plurality of possible coaching scenarios.

5. A system according to claim 4, wherein said user can modify at least one of said plurality of possible coaching scenarios.

6. A system according to claim 5, wherein said user can share said modified possible coaching scenario with a second user.

7. A system according to claim 4, wherein said system further comprises a database and each of said plurality of possible coaching scenarios is a record in a table in said database.

8. A system according to claim 7, wherein said user may modify said database, a second user may modify a second database and at least one of said database and said second database may be shared between said user and said second user despite any modifications to said database and said second database.

9. A system according to claim 7, wherein said database comprises a plurality of tables.

10. A system according to claim 9, wherein said plurality of tables include a playbook table, an entity table, a category table and a detail table.

11. A system according to claim 10 wherein records in said detail table have a one-to-many relationship to records in said playbook table.

12. A computer program product, comprising a computer usable medium having a computer readable program code embodied therein, said computer readable program code adapted to be executed to implement a process for coaching a job-seeker, said process comprising:
inputting information related to a job-search activity;
analyzing said information to determine an applicable coaching scenario from a plurality of possible coaching scenarios;
presenting said applicable coaching scenario to said job-seeker;
creating a follow-up activity.

13. A computer program product according to claim 12, wherein said step of analyzing comprises evaluating triggering criteria for each of said plurality of possible coaching scenarios.

14. A computer program product according to claim 13, wherein said triggering criteria comprise at least one of entity, type or status.

15. A computer program product according to claim 12, wherein said presenting step is initiated by said job-seeker.

16. A computer program product according to claim 12, wherein said presenting step occurs automatically.

17. A method for coaching a user conducting a job search comprising:
prompting said user to enter an identifier via a machine having an input-output device;
transmitting said identifier from said machine to a server;
authenticating said user based on said identifier;
retrieving data related to a job search for said user from a database having a plurality of tables;
analyzing said data to determine possible coaching scenarios; and
displaying said data to said user on a visual display;

18. A method for coaching a user conducting a job search according to claim 17 further comprising:
receiving new or changed information related to said job search;
storing said new or changed information in at least one of said plurality of tables of said database;
reviewing said new or changed information;
assessing changes to said possible coaching scenarios;
transmitting an updated coaching scenario to said machine; and
displaying said updated coaching scenario on said visual display.

19. A method for coaching a user conducting a job search according to claim 17, wherein said analyzing step is performed by a rules engine through a series of data driven rules.

20. A method for coaching a user conducting a job search according to claim 19, wherein said server comprises a microprocessor and said microprocessor performs said analyzing step.
